(19) United States
(12) Patent Application Publication
(10) Pub. No.: US 2007/0032948 A1
(43) Pub. Date: Feb. 8, 2007

(54) Automobile navigation system

(75) Inventor: Noriko Kato, Toyoake-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/496,406

(22) Filed: Aug. 1, 2006

(30) Foreign Application Priority Data
Aug. 2, 2005 (JP) 2005-224249

(51) Int. Cl. G01C 21/00

(52) U.S. Cl. 701/209; 701/201; 340/995.23

(57) ABSTRACT

In an automobile navigation system, one of search conditions including a category search, an address search, or the like is selected by a user to specify a destination for computing a guided route from a present position. Next, an additional search condition to search for spots existing within a predetermined range with the present position at the center is confirmed without need of an operation of the user. Then spots that meet the search condition selected by the user and the confirmed additional search condition are searched for. For this reason, spots to be detected after the search are limited to any of spots existing within the predetermined range with the present position at the center. Thus, it is possible for the user to specify the user's desired spot as the destination around the present position without specifying an area or the like as a search condition.

### CROSS REFERENCE TO RELATED APPLICATIONS

This application is based on and incorporates herein by reference Japanese Patent Application No. 2005-224249 filed on Aug. 2, 2005.

### FIELD OF THE INVENTION

The present invention relates to an automobile navigation system capable of computing a guided route from a present position to a destination and providing routing assistance based on the thus computed guided route.

### BACKGROUND OF THE INVENTION

A user may not clearly memorize a place or spot the user intends to take as a destination. In such a case, a conventional automobile navigation system requires the user to input search conditions for search to narrow down categories or area in succession. The place the user intends is thus set as the destination.

To simplify such cumbersome operation to lessen the burden on users, various techniques have been recently proposed. An example of such proposals is a technique to use the record of search and setting in the past for subsequent searches. (Refer to Patent Document 1.)
Patent Document 1: JP-2005-156290 A

With the above-mentioned technique as well, a user still has to input search conditions one by one to narrow categories or areas. Therefore, it cannot be said that automobile navigation systems based on this technique are sufficiently high in the degree of ease of operation.

### SUMMARY OF THE INVENTION

The invention has been made to solve such a problem. It is an object of the invention to provide a technique to enhance the degree of ease of operation of automobile navigation systems.

According to an aspect of the present invention, a navigation system is provided with the following. A present position identifying means is included to identify a present position. A condition specifying means is included with which a user specifies a search condition for searching a destination. A spot searching means is included to search a database, in which each spot is stored in association with information including a site of the each spot, for at least one spot that meets the specified search condition. A spot specifying means is included with which the user specifies a certain spot from among the at least one spot detected by the spot searching means. A destination setting means is included to set the certain spot as the destination. Here, the certain spot specified by the user with the spot specifying means is limited to be included within a predetermined region including the present position.

According to another aspect of the present invention, a navigation system is provided with the following. A present position identifying means is included to identify a present position. A condition specifying means is included with which a user specifies a search condition under which a destination is searched for, through a predetermined input operation. A spot searching means is included to search a database, in which each spot is stored in association with information including a site of the each spot, for at least one spot that meets the specified search condition. A spot specifying means is included with which the user specifies a certain spot from among the at least one spot detected by the spot searching means. A destination setting means is included to set the certain spot as the destination. A condition storing means is included to store in a storage unit the search condition specified through the predetermined input operation by the user. A preferentially inputting means is included, wherein, when an input operation to specify a search condition is started again by the user with the condition specifying means after the search condition was specified by the user and before a spot is specified by the user with the spot specifying means, the preferentially inputting means allows the input operation performed by the user to preferentially specify the search condition stored in the storage unit.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram illustrating an overall configuration of an automobile navigation system as an example according to embodiments of the present invention;

FIG. 2 is a flowchart illustrating routing assistance processing in an example of a first embodiment; and

FIG. 3 is a flowchart illustrating routing assistance processing in an example of a second embodiment.

### DETAILED DESCRIPTION OF THE PREFERRED EMBODIMENTS

Hereinafter, description will be given to embodiments of the invention with reference to drawings.

### (1) Overall Configuration

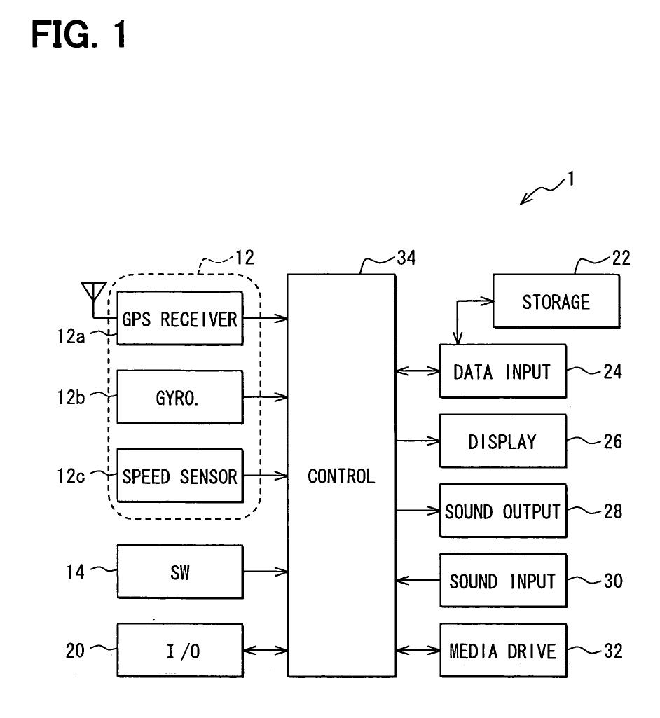

As illustrated in FIG. 1, an automobile navigation system 1 in a subject vehicle, as an example of the embodiments, includes: a present position identification unit 12 that identifies a present position of the automobile navigation system 1 itself (or the subject vehicle); an operation switch group 14 for inputting various instructions from a user; an external information input/output unit 20 that communicates information between the automobile navigation system 1 and sources outside of the navigation system; a data input/output unit 24 that communicates data with a storage unit 22 that stores map data and varied information; a display unit 26 for displaying various windows (or screen windows) such as a map display window and a TV footage window; a sound output unit 28 for outputting various guide sound and the like; a sound input unit 30 for inputting sound from the user; a media drive 32 that communicates data with media such as CD, DVD, or memory card; and a control unit 34 that controls the operation of each component.

The present position identification unit 12 as a position detector is constructed of: a GPS receiver 12a that receives radio waves transmitted from artificial satellites for GPS (Global Positioning System) through a GPS antenna and detects the position, orientation, speed, and the like of the automobile navigation system 1 itself; a gyroscope 12b that detects the magnitude of rotational motion applied to the subject vehicle; a vehicle speed sensor 12c that detects the speed of the vehicle in the longitudinal direction based on a vehicle speed pulse generated by a vehicle speed pulse generator; and the like. These sensors respectively have errors different in property. Therefore, present position information (coordinates) indicating the present position of the automobile navigation system 1 itself is acquired by complementarily using these sensors.

The operation switch group 14 includes a touch panel provided along the display surface of the display unit 26, and key switches provided on the periphery of the display unit 26.

The external information input/output unit 20 receives FM broadcast signals and radio beacon signals and light beacon signals transmitted from fixed stations for VICS (Vehicle Information and Communication System) service, installed by the side of roads. Then, it acquires traffic information (traffic jam information, accident/roadwork information, traffic regulation information, etc.) identified by these signals.

The storage unit 22 stores varied data on storage media (e.g., hard disk). Such data includes information on roads, map data constructed of a spot database, and data for map matching intended to enhance the position detection accuracy. The above-mentioned spot database is a database in which the names of spots that can be set as a destination are stored in association or correspondence with the categories of individual spots, position information (coordinates) indicating the sites of individual spots, and the like.

The control unit 34 is constructed on the basis of a publicly known microcomputer constructed of CPU, ROM, RAM, I/O, bus lines that connect these components, and the like. Based on programs stored in the ROM, the coordinates and the traveling direction are computed as the present position of the subject vehicle from detection signals from the present position identification unit 12. Then, map display processing, routing assistance processing, and the like are carried out. The “map display processing” is processing to cause the display unit to display map data about the area in the vicinity of the present position read through the data input/output unit 24 or map data about the range instructed through operation with the operation switch group 14. The “routing assistance processing” is processing to set a destination, carry out route computation to automatically determine the optimum route from the present position to the destination, and provide routing assistance.

### (2) First Embodiment

Hereinafter, description will be given to an example of an embodiment (first embodiment) of the automobile navigation system 1 of the above construction.

(2-1) Routing Assistance Processing by Control Unit

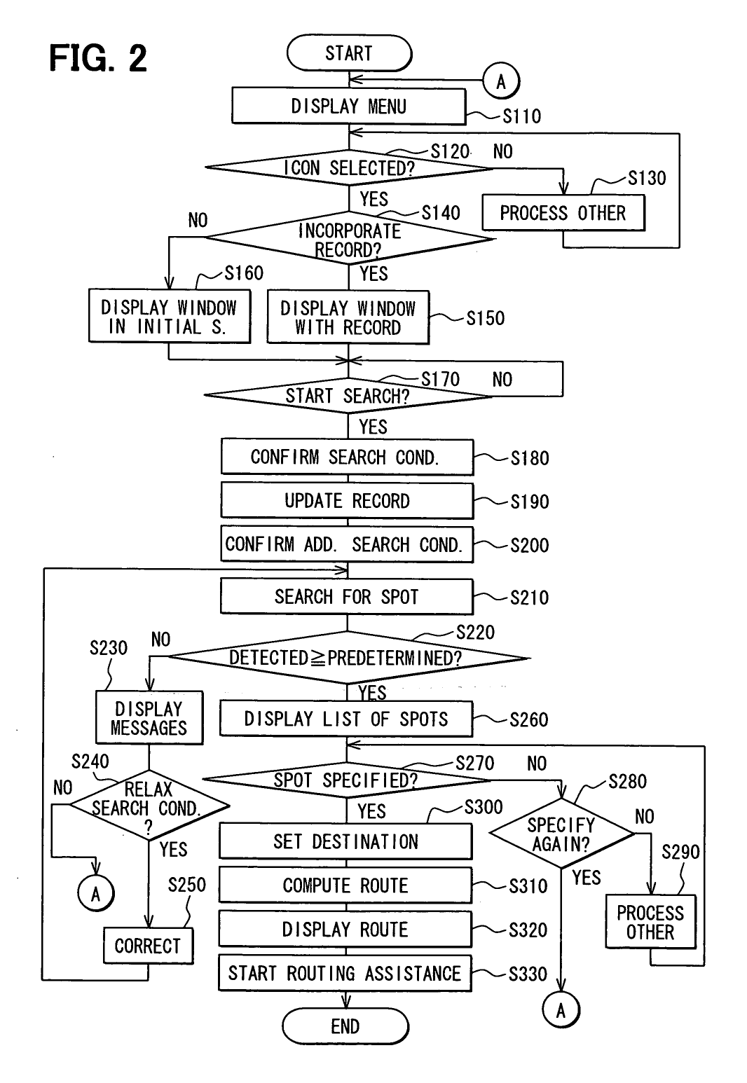

Here, description will be given to the procedure for routing assistance processing carried out by the control unit 34 with reference to FIG. 2. This routing assistance processing is started by performing the operation to cause the display unit 26 to display a menu window with the operation switch group 14.

When the routing assistance processing is started, the menu window is displayed on the display unit 26 (S110). Here, displayed is the menu window in which icons indicating the following options are shown with respect to the setting of a place or spot (e.g., POI (point of interest) as a destination for which running guidance is requested: option to narrow down the setting by character entry of the spot (entry of full or part of characters of the spot); option to narrow it down by the category of the spot; option to narrow it down by the address of the spot; option to narrow it down by the phone number for the spot (e.g., facility phone number); and option to narrow it down by the postal code for the area in the vicinity of the spot. After the menu window is displayed as mentioned above, the user can perform operation to select any icon or any other like operation by operating the operation switch group 14.

When the operation switch group 14 is operated after the menu window is displayed at S110, it is checked whether or not that operation is the operation to select any icon mentioned above (S120).

When it is determined at S120 that the operation performed with the operation switch group 14 is not the operation to select any icon mentioned above (S120: NO), the processing corresponding to that operation performed with the operation switch group 14 (other processing) is carried out (S130), and the processing is returned to S120. When the operation to terminate this routing assistance processing is performed here, the processing is not returned to S120 but this routing assistance processing itself is terminated.

When it is determined at S120 that the operation performed with the operation switch group 14 is the operation to select any icon described above (S120: YES), it is checked whether or not the record of operation stored in the storage unit 22 should be incorporated into a condition specification window to be described (S140). This example is so constructed that the following information is stored in the storage unit 22 as the record of operation: operation information that indicates input operation performed until a search condition, to be described, is specified; time information that indicates the time of that operation; and type information indicating the type of the icon selected in the menu window. At S140, it is checked whether or not the current time is before a predetermined wait time (e.g. 10 seconds) has passed after the time of operation indicated by time information. Then, it is checked whether or not the type of the icon indicated by the type information stored in the storage unit 22 is consistent with the type of the icon selected in the menu window displayed immediately before. In the case where the predetermined wait time has not passed yet and the types of the icons are consistent with each other, it is determined that the record of operation should be incorporated into the condition specification window.

The operation information in the above-mentioned record of operation is information whose contents correspond to the type of icon indicated by the type information. The contents of the operation information are as follows:
Icon for the option of search refinement by character entry → Inputted character string
Icon for the option of search refinement by the category of the spot → Selected category
Icon for the option of search refinement by the address of the spot → Selected address
Icon for the option of search refinement by the phone number for the facility to be set as the destination → Selected phone number
Icon for the option of search refinement by the postal code for the area in the vicinity of the spot → Selected postal code

When it is determined at S140 that the record of operation should be incorporated into the condition specification window (S140: YES), the condition specification window for the user to specify a search condition for a spot to be set as the destination is displayed on the display unit 26. The condition specification window is displayed with the record of operation, stored in the storage unit 22, incorporated into the window (S150). Here, of the record of operation stored in the storage unit 22, the same data as the data indicated by the operation information has been already inputted as a search condition in the condition specification window. After the condition specification window is displayed as mentioned above, the user can perform operation to start search based on the search condition already inputted at that point of time. The user may perform this operation after he/she performs operation to correct any search condition already inputted or without performing such correcting operation.

When it is determined at S140 that the record of operation should not be incorporated in the condition specification window (S140: NO), the condition specification window in the initial state is displayed on the display unit 26 (S160). Here, the condition specification window is displayed as is in initial state in which none of data to be inputted as search conditions has been inputted. After the condition specification window is displayed as mentioned above, the user performs operation to input a search condition with the operation switch group 14, and then he/she can perform operation to start search based on the thus inputted search condition.

After the condition specification window is displayed at S150 or S160 mentioned above, the automobile navigation system is brought into and kept in standby state (S170: NO) until the operation to start search is performed.

When the operation to start search is thereafter performed (S170: YES), the data already inputted in the condition specification window at that point of time is confirmed as a search condition (S180).

Then, the record of operation stored in the storage unit 22 is altered in correspondence to the operation performed up to this point of time (S190). Here, the operation information in the record of operation is updated with data already inputted when the operation to start search was performed at S170. Further, the time information is updated with data indicating the current time. The type information is updated with data indicating the type of the icon selected in the menu window displayed immediately before.

Then, it is confirmed as an additional search condition that a predetermined range with the present position, identified by the present position identification unit 12, at the center should be searched (S200). This example is so constructed that the target of search can be selectively changed from among the following options: option in which the range at a predetermined distance (e.g. 5 km) from the present position should be searched (first target); option in which an addressable area which the present position belongs to and can be addressed or designated using a variety of information (e.g., a local municipal entity including city, ward, town, and village; a voting district; an area corresponding to a postal code (or zip code); and an area corresponding to a local area code of phone number) should be searched (second target); and option in which the activity field of the user of the automobile navigation system 1 should be searched (third target). Then, the additional search condition is confirmed in correspondence with the state of changing of the target of search.

“User's activity field” as the third target, cited here, is estimated based on the record of the present position identified by the present position identification unit 12. This example is so constructed that the record of the present position is stored in the storage unit 22 for a certain period (e.g. one year) in the past. When the target of search has been changed to the third target, the following operation is performed at S200: the addressable area (e.g. city, ward, town, and village) which each present position belongs to and is stored as the record in the storage unit 22 is included is identified as a unit area; and the region constructed of unit areas, identified as mentioned above, is estimated as the activity field.

When the present position identified by the present position identification unit 12 is within the estimated activity field at this point of time, the activity field estimated as mentioned above is confirmed as the target of search. Or, when the present position identified by the present position identification unit 12 is not away from the activity field by a predetermined distance (e.g. 5 km) or longer, the activity field estimated as mentioned above is confirmed as the target of search. When the present position is away from the estimated activity field by a predetermined distance or longer, the target of search is changed to the first target (or the second target), and then the additional search condition is confirmed in correspondence with the state of changing of the target of search.

To estimate an activity field, the following construction may be adopted: the specified area with each present position, stored as the record in the storage unit 22, at the center is identified as a unit area. A region consisting of the thus identified unit areas is estimated as the above-mentioned activity field. An example of the specified area may be within an X m radius with the present position at the center (X is an arbitrary value).

Based on the present position identified by the present position identification unit 12, spots that meet the search condition confirmed at S180 and the additional search condition confirmed at S200 are searched for from the spot database of the map data (S210).

Then, it is checked whether or not the number of spots (or a spots count) detected at S210 is equal to or larger than a predetermined number (one in the case of this example) (S220). When it is determined that the number of spots detected at S220 is not equal to or larger than the predetermined number (S220: NO), messages notifying the following are displayed on the display unit 26 (S230): a message reading that the search conditions should be relaxed because the predetermined number or more of spots were not found; and a message reading that the user should specify whether to permit a relaxation of the search conditions. After these messages are displayed, the user can perform operation to specify that he/she will or will not permit the relaxation of the search conditions with the operation switch group 14.

When the operation to specify that the relaxation of the search conditions will not be permitted is performed with the operation switch group 14 after the messages are displayed (S240: NO), the processing is returned to S110, and is carried out again from display of the menu window.

When the operation to specify that the relaxation of the search conditions will be performed is performed (S240: YES), the additional search condition confirmed at S200 is corrected (S250), and then the processing proceeds to S210. The processing is carried out again from search for spots that meet the search condition confirmed at S180 and the search condition corrected at S250.

At S250, the additional search condition is corrected in correspondence with the state of changing of the target of search so that spots existing in a wider region containing the region previously set as a search condition should be searched for. Some examples will be taken. When the target of search is changed to the first target, the target of search is corrected to a range away from the present position by a distance obtained by adding a certain distance (e.g. 1 km) to the distance for the previous target of search. When the target of search is changed to the second target, the target of search is corrected to a range consisting of the area previously set as the target of search and areas that adjoin that area and was not set as the target of search. When the target of search is changed to the third target, the activity field as the target of search is corrected to a range defined by expanding the region previously taken as the activity field by a certain distance (e.g. 1 km).

When it is determined at S220 that the number of the detected spots is equal to or larger than the predetermined number (S220: YES), a list of pieces of information related to the thus detected spots is displayed on the display unit 26 (S260). Here, in addition to the information (name, category, distance from the present position, etc.) related to the spots, a message reading that any spot should be specified as the destination is also displayed. After the list of pieces of information related to spots is displayed, the user can perform the following operation with the operation switch group 14: operation to specify any spot; operation to specify a search condition again; or the like.

When, after the list of pieces of information related to spots is displayed at S260, it is determined that any operation other than the operation to specify any spot and the operation to specify a search condition again has been performed with the operation switch group 14 (S270: NO, S280: NO), the following takes place. The processing corresponding to that operation (other processing) is carried out (S290), and then it is returned to S270. When the operation to terminate this routing assistance processing is performed here, the processing is not returned to S270 and this routing assistance processing itself is terminated.

When it is determined that the operation to specify a search condition again has been performed with the operation switch group 14 (S280: YES), the processing is returned to S110 and is carried out again from display of the menu window.

When it is determined that the operation to specify any spot has been performed with the operation switch group 14 (S270: YES), the thus specified spot is set as the destination (S300).

When the destination is set at S300, as mentioned above, the guided route from the present position to the destination is determined (S310). Here, a route formed with respect to each of connection links from the present position identified by the present position identification unit 12 to the destination set at S300 is computed based on the map data stored in the storage unit 22. The thus computed routes are determined as a guided route and stored in the built-in memory of the control unit 34.

A guided route determined at S310 is displayed on the display unit 26 (S320), and then routing assistance (running guidance) according to this guided route is started (S330).

(2-2) Action and Effect

According to the thus constructed automobile navigation system 1, it is confirmed as the additional search condition at S200 in FIG. 2 that a predetermined range with the present position at the center should be taken as the target of search. Then, spots that meet this search condition are searched for at S210 in the same drawing. For this reason, a spot to be specified by the user at S260 in the same drawing is limited to any of spots existing within the predetermined range with the present position at the center. Therefore, the user can specify as the destination the user's desired spot from among spots existing within the predetermined range with the present position at the center, that is, around the present position without specifying an area or the like as a search condition.

Thus, the user can select his/her desired spot from among only spots existing around the present position without limiting an area as a search condition, looking for any spot around the present position from a search result, or performing other like operations. As a result, the operation can be simplified to lessen the burden on the user.

In this example, the following processing is carried out with the target of search, which is referred to when the additional search condition is confirmed, changed to the first target: the range at a predetermined distance from the present position is taken as the target of search at S200 in FIG. 2. That is, it is set as the additional search condition that spots existing within this range should be searched for. Thus, the spots detected at S210 in the same drawing are only spots existing within the range at the predetermined distance from the present position. As a result, a spot to be specified by the user at S270 in the same drawing can be limited to any of spots existing within the range at the predetermined distance from the present position.

In this example, the following processing is carried out with the target of search, which is referred to when the additional search condition is confirmed, changed to the second target: the area in which the present position is included (or the region including its peripheral areas) is taken as the target of search at S200 in FIG. 2. That is, it is set as the additional search condition that spots existing within this area should be searched for. Thus, the spots detected at S210 in the same drawing are only spots existing within the area in which the present position is included (or the region including its peripheral areas). As a result, a spot to be specified by the user at S270 in the same drawing can be limited to any of spots existing within the area in which the present position is included (or the region including its peripheral areas).

In this example, the following processing is carried out with the target of search, which is referred to when the additional search condition is confirmed, changed to the third target: the user's activity field is taken as the target of search at S200 in FIG. 2. That is, it is set as the additional search condition that spots existing within the activity field should be searched for. Thus, the spots detected as S210 in the same drawing are only spots existing within the user's activity field. As a result, a spot to be specified by the user at S270 in the same drawing can be limited to any of spots existing within the user's activity field.

With such construction that a spot to be specified by a user is limited to any of spots within the user's activity field, it can be said that a spot existing in a place familiar to the user and easily accessible to the user is to be specified. For this reason, it can be expected that information related to a spot more likely to be desired by the user will be preferentially provided.

With the target of search, which is referred to when the additional search condition is confirmed, changed to the third target, the following processing is carried out at S200 in FIG. 2: when the present position is within the activity field, this state of changing is maintained; when the present position is not within the activity field, the target of search is changed to the first target (or the second target). Thus, a spot to be specified by the user at S270 in the same drawing can be limited to any of spots within the user's activity field or within the area in which the present position is included (or the region including its peripheral areas) depending on whether or not the present position is within the activity field.

This example is so constructed that the following processing is carried out when, as the result of spot search, no spot is detected or only a number of spots smaller than a predetermined number are detected (S220 in FIG. 2: NO): spots are searched for again under a more relaxed search condition (S250 to S210 in the same drawing). Specifically, the additional search condition is corrected so that spots existing in a wider region containing the region previously set as a search condition should be searched for. Thus, when no relevant spot is detected or only a number of spots smaller than a predetermined number are detected, the following can be implemented: spots can be searched for again from a wider region containing the region previously set as a search condition. As a result, the room for choice can be expanded when a spot to be taken as the destination is specified.

In this example, the following processing is carried out when the user specifies a search condition again after he/she specified the search condition: the condition specification window in which the record of operation made when that search condition was specified is incorporated is displayed (S150 in FIG. 2). Specifically, the same data as indicated by the operation information in the record of operation has been already inputted as a search condition in the condition specification window. More specific description will be given. When the user attempts to specify a search condition again, the same input operation as was performed when the search condition was previously specified has been already completed, and the user can preferentially specify that search condition. For this reason, when the user desires to specify that search condition, he/she can specify that search condition again without performing input operation.

At this time, the user can perform input operation in state in which the previously specified search condition can be preferentially specified, provided a predetermined wait time has not passed yet after the search condition was previously specified (S140 in the same drawing). When the time that lapsed after a search condition was previously specified is short, the user is probably repeating the search condition, having a desire to also check unconfirmed spots detected under the same search condition or spots detected under a similar search condition. When the time that lapsed after a search condition was previously specified is too long, meanwhile, there is the possibility that the user's desire has become different from the above-mentioned desire. For this reason, the probability that the user's desire can be appropriately met can be enhanced by adopting the following as the condition for ensuring that a previously specified search condition can be preferentially specified, as mentioned above: a predetermined wait time should not have passed after the search condition was previously specified. That is, the above-mentioned “predetermined wait time” can be set to a time for which the user is supposed to sustain the above-mentioned desire.

In this example, when a user specifies a search condition again, he/she can perform specifying operation in such a manner that he/she can preferentially specify the previously specified search condition. For this reason, when the user specifies a search condition again, the time and manpower consumed when input operation is performed to repeatedly specify the same search condition can be reduced. This makes it easy to perform the same operation again to specify the previous search condition. Since the same operation can be easily performed again, as mentioned above, the time required to finally set a spot as the destination can also be shortened.

### (3) Second Embodiment

Hereinafter, description will be given to an example of an embodiment (second embodiment) of the automobile navigation system 1 of the above construction.

(3-1) Routing Assistance Processing by Control Unit

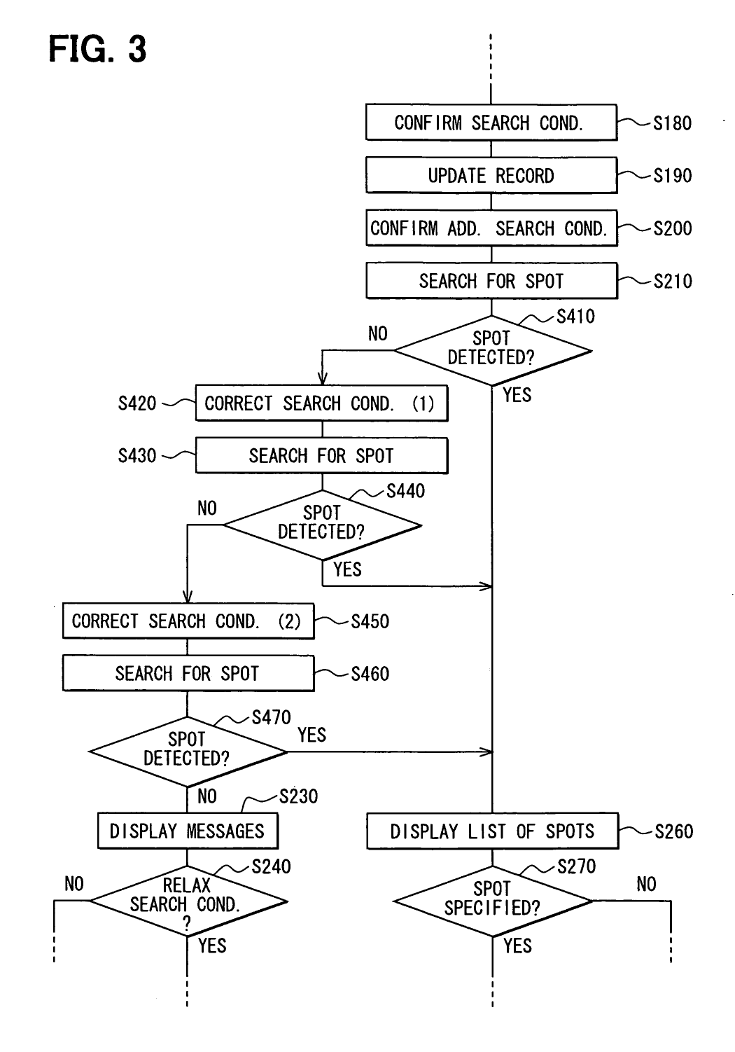

Here, description will be given to the procedure for routing assistance processing carried out by the control unit 34 with reference to FIG. 3. The routing assistance processing in this example is characterized in the processing carried out when the operation to select the icon for search refinement by category is performed in the menu window. When the operation is performed to select any other icon, the same processing as in the first example is carried out. Therefore, the following description is on the assumption that the operation is performed to select the icon for search refinement by the category of spot, and detailed description will be given only to the characteristic portions of this processing.

First, the processing of S110 to S210 is carried out, and it is checked whether or not spots were detected at S210 S410). When it is determined at S410 that spots have been detected (S410: YES), the processing proceeds to S260 and the subsequent processing is carried out.

When it is determined at S410 that no spot has been detected (S410: NO), the search condition confirmed at S180 is corrected to an upper-level category (or generic category) (correction (1)) (S420). Here, explanation for the upper-level category or the generic category below. Category was confirmed as the search condition by the above-mentioned processing of S180. This category was confirmed by the following operating procedure: at first, a convenience store in general (e.g., including several different franchise chains) that is the upper-level category is specified and then a specific convenience store (e.g., a specific franchise chain) is confirmed as category from within the convenient store in general being the upper-level category. At S420, the category confirmed as the search condition at S180 is corrected to the upper-level category.

Then, as at S210, spots that meet the search condition corrected at S420 and the additional search condition confirmed at S200 are searched for (S430). It is checked whether or not spots were detected at S430 (S440). When it is determined that spots have been detected (S440: YES), the processing proceeds to S260 and the subsequent processing is carried out.

When it is determined that no spot was detected at S430 (S440: NO), the search condition corrected at S420 is corrected to a relevant category (correction (2)) (S450). In this example, the storage unit 22 holds a correspondence table in which each category that can be selected at S120 is entered in correspondence with other categories related to that category. At S450, the category as the search condition corrected at S420 is corrected to another category entered in the above-mentioned correspondence table in correspondence therewith, that is, a different related category. In this correspondence table, for example, “supermarket,” “department store,” and the like are entered in correspondence with convenience store.

Then, as at S210, spots that meet the search condition corrected at S450 and the additional search condition confirmed at S200 are searched for (S460). It is checked whether or not spots were detected at S460 (S470). When it is determined that spots have been detected (S470: YES), the processing proceeds to S260 and the subsequent processing is carried out. When it is determined at S470 that no spot has been detected (S470: NO), the processing proceeds to S230 and subsequent processing is carried out.

(3-2) Action and Effect

According to the thus constructed automobile navigation system 1, the action and effect described below can be obtained in addition to the action and effect obtained with the same construction as the above-mentioned example of the first embodiment.

When, in the above automobile navigation system 1, no spot that meets the search condition confirmed first is detected, spots that belong to the same category as the category to which the undetected spot belongs are searched for again.

An example will be taken. In general, a user's desire to take a specific spot as the destination is formed for the purpose of finishing a specific job at that point. For this reason, the user's desire can often be satisfied even at any other spot that belongs to the same category as that spot. In general, for example, a desire to take some convenience store as the destination is formed for the purpose of purchasing a specific article at that convenience store of a certain convenience-store franchise chain. For this reason, the desire can be satisfied even at any other convenience store (convenience store belonging to a different convenience-store franchise chain) as long as the identical article can be purchased.

As a result, an automobile navigation system so constructed that it simply reports that spots that meet a search condition have not been detected poses a problem. The thus constructed navigation system does not provide the user with information even when other spots that will satisfy the user's desire exist in proximity to the present position. For this reason, the navigation system of such construction cannot sufficiently satisfy the user's desire.

Meanwhile, the automobile navigation system of the invention is so constructed that, when no relevant spot is detected, spots belonging to the same category are searched for again, as mentioned above. This navigation system is capable of searching for spots that will satisfy the user's desire from among spots other than the spot specified by the user, belonging to the same category, and providing the user with that information.

As mentioned above, this example is so constructed that the following processing is carried out: when no spot that meets the search condition confirmed first is not detected, spots belonging to the same category as the category to which the undetected spot belongs are searched for again; when no relevant spot is detected after all, spots belonging to a category related to the category to which the undetected spot belongs are searched for again. For this reason, when no relevant spot is detected, this example is capable of searching for spots that will satisfy the user's desire from among spots belonging to a related category, other than spots belonging to the category to which the spot specified by the user belongs, and providing the user with that information.

### (4) Modifications

Up to this point, description has been given to examples of the embodiments of the invention. However, the invention is not limited to the above-mentioned examples, and various modifications can be made to the invention without departing from its technical scope, needless to add.

Some examples will be taken. In the examples described in relation to the above embodiments, map data is stored in the storage unit 22. Instead, the following construction may be adopted: all or part (spot database, etc.) of the map data is stored in any other device that can communicate data with the automobile navigation system 1.

The above embodiments described as examples are so constructed that the following processing is carried out when a user attempts to specify a search condition again after he/she specified the search condition: the condition specification window with all the previously specified search conditions entered is displayed so that this search condition can be preferentially specified. All the previously specified search conditions need not be placed in this condition specification window. The invention may be so constructed that only some of the previously specified search conditions are placed in the window.

Any other construction may be adopted to ensure that, when a search condition is specified again, the previously specified search condition can be preferentially specified. For example, the following constructions are possible: when the condition specification window is displayed at S150 in FIG. 2, of multiple types of search conditions, the previously specified search condition is disposed in a window position in which it can be most easily selected. (For example, it is disposed on the uppermost line or in the same window position as the cursor.) Or, it is decorated so that it is most conspicuous.

In the examples described in relation to the above examples, spots within a predetermined range with the present position at the center are presented so that the user can specify any of them as the destination, by confirming the additional search condition. However, the construction for presenting spots within a predetermined range with the present position at the center so that the user can specify any of them as the destination is not limited to the foregoing. For example, the following construction may be adopted: when the list of the detected spots is displayed at S260 in FIG. 2, only the spots within a predetermined range with the present position at the center are extracted, and only the thus extracted spots are displayed in the form of list.

### (5) Correspondence with the Invention

In the embodiments mentioned above, the control unit 34 that identifies the present position by the present position identification unit 12 corresponds to the present position identifying means in the invention.

Each or any combination of processing, steps, or means explained in the above can be achieved as a software unit (e.g., subroutine) and/or a hardware unit (e.g., circuit or integrated circuit), including or not including a function of a related device; furthermore, the hardware unit can be constructed inside of a microcomputer.

Furthermore, the software unit or any combinations of multiple software units can be included in a software program, which can be contained in a computer-readable storage media or can be downloaded and installed in a computer via a communications network.

It will be obvious to those skilled in the art that various changes may be made in the above-described embodiments of the present invention. However, the scope of the present invention should be determined by the following claims.

What is claimed is:

1. A navigation system for performing routing assistance based on a guided route computed using a present position and a destination; the system comprising:
a present position identifying means that identifies a present position;
a condition specifying means with which a user specifies a search condition for searching a destination;
a spot searching means that searches a database, in which each spot is stored in association with information including a site of the each spot, for at least one spot that meets the specified search condition;
a spot specifying means with which the user specifies a certain spot from among the at least one spot detected by the spot searching means; and
a destination setting means that sets the certain spot as the destination,
wherein the certain spot specified by the user with the spot specifying means is limited to be included within a predetermined region including the present position.

2. The navigation system of claim 1, further comprising:
an additional condition setting means that sets an additional search condition, under which the spot searching means searches for a spot that is limited to be within the predetermined region including the present position,
wherein the spot searching means searches the database for the at least one spot that meets the additional search condition set by the additional condition setting means in addition to the search condition specified by the user with the condition specifying means.

3. The navigation system of claim 2, further comprising:
an activity estimating means that estimates a user's activity field based on a record of a present position identified by the present position identifying means,
wherein the additional condition setting means sets an additional search condition, under which the spot searching means searches for a spot, wherein the spot is limited to be within an activity field, which is estimated by the activity estimating means and includes the present position.

4. The navigation system of claim 2,
wherein the additional condition setting means sets an additional search condition, under which the spot searching means searches for a spot, which is limited to be within an area to which the present position belongs.

5. The navigation system of claim 2,
wherein the additional condition setting means sets an additional search condition, under which the spot searching means searches for a spot, wherein the spot is limited to be within an area with a predetermined radius centered on the present position.

6. The navigation system of claim 2, further comprising:
an activity estimating means that estimates a user's activity field based on a record of a present position identified by the present position identifying means,
wherein, when the present position is within the activity field, the additional condition setting means sets an additional search condition under which the spot searching means searches for a spot, which is limited to be within the activity field, and
wherein, when the present position is out of the activity field, the additional condition setting means sets the additional search condition under which the spot searching means searches for a spot, which is limited to be within an area to which the present position belongs.

7. The navigation system of claim 2,
wherein, where a predetermined number or more of spots are not detected by the spot searching means, the additional condition setting means re-sets an additional search condition under which the spot searching means searches for a spot, which is included in a region which contains the predetermined region including the present position, and
wherein the spot searching means re-searches the database for at least one spot that meets the additional search condition re-set by the additional condition setting means in addition to the search condition specified by the user with the condition specifying means.

8. The navigation system of claim 1,
wherein the database stores the each spot associated with a category, to which the each spot belongs, in addition to the site of the each spot,
wherein the condition specifying means causes the user directly or indirectly to specify as a search condition a spot and a category to which the specified spot belongs, and
wherein, when the spot specified by the user with the condition specifying means is not detected, the spot searching means searches the database again for a spot belonging to a category upper-leveled from the category to which the spot specified by the user with the condition specifying means belongs.

9. The navigation system of claim 8,
wherein, where a spot belonging to the upper-leveled category is not detected, the spot searching means re-searches the database again for a spot belonging to a category related to the category to which the spot specified by the user with the condition specifying means belongs.

10. A navigation system for performing routing assistance based on a guided route computing using a present position and a destination; the system comprising:
a present position identifying means that identifies a present position;
a condition specifying means with which a user specifies a search condition under which a destination is searched for, through a predetermined input operation;
a spot searching means that searches a database, in which each spot is stored in association with information including a site of the each spot, for at least one spot that meets the specified search condition;
a spot specifying means with which the user specifies a certain spot from among the at least one spot detected by the spot searching means;
a destination setting means that sets the certain spot as the destination;
a condition storing means that stores in a storage unit the search condition specified through the predetermined input operation by the user; and
a preferentially inputting means that, when an input operation to specify a search condition is started again by the user with the condition specifying means after the search condition was specified by the user and before a spot is specified by the user with the spot specifying means, allows the input operation performed by the user to preferentially specify the search condition stored in the storage unit.

11. The navigation system of claim 10,
wherein the preferentially inputting means establishes such a state in which at least part of an input operation necessary for specifying a search condition with the condition specifying means has been already completed, based on the search conditions stored in the storage unit.

12. The navigation system of claim 10,
wherein, when an input operation to specify a search condition is started again by the user after the search condition was specified by the user, before a spot is specified by the user, and before a predetermined wait time has not passed, the preferentially inputting means allows the input operation performed by the user to preferentially specify the search condition stored in the storage unit.

13. A computer program product in a computer-readable medium for use in a navigation system, the product comprising instructions for achieving the means included in the navigation system of claim 1.

14. A computer program product in a computer-readable medium for use in a navigation system, the product comprising instructions for achieving the means included in the navigation system of claim 10.

15. A navigation system for performing routing assistance based on a guided route from a present position to a destination; the system comprising:
a position detector used to identify a present position;
a condition specifying unit with which a user specifies a search condition for searching a destination;
a spot searching unit that searches a database, in which each spot is stored in association with information including a site of the each spot, for at least one spot that meets the specified search condition;
a spot specifying unit with which the user specifies a certain spot from among the at least one spot detected by the spot searching unit; and
a destination setting unit that sets the certain spot as the destination,
wherein the certain spot specified by the user with the spot specifying unit is limited to be included within a predetermined region including the present position.
